(19) United States
(12) Patent Application Publication
(10) Pub. No.: US 2024/0179083 A1
(43) Pub. Date: May 30, 2024

(54) NETWORK DEVICE TESTING SYSTEM AND METHOD

(71) Applicant: Rakuten Mobile, Inc., Tokyo (JP)

(72) Inventors: Siddhartha TRIVEDI; Awn MUHAMMAD

(21) Appl. No.: 17/758,030

(22) PCT Filed: Apr. 29, 2022
(86) PCT No.: PCT/US2022/026892

§ 371 Date: Jun. 27, 2022

(51) Int. Cl. H04L 43/50; H04L 43/20

(52) U.S. Cl. CPC H04L 43/50; H04L 43/20

(57) ABSTRACT

Systems and methods of testing a device for a computer network are disclosed. In some embodiments, a testing scenario is executed on one or more virtual machines (VMs) implemented by at least one computer device so that the one or more VMs generate input data as result of executing the testing scenario. A network device under test (NDUT) runs the testing scenario to generate test result data in response to the input data from the one or more VMs. Whether the NDUT passes the testing scenario is detected based on the test result data.

### BACKGROUND

A telecommunication network system includes network devices and other types of hardware. Some of this hardware implements software to perform network functions. In some cases, new hardware and/or software is to be integrated into the network. However, this hardware and/or software is tested prior to integration into the computer network to ensure that the hardware and/or software operates appropriately and is unable to cause other problems on the computer network. The hardware and/or software is tested in a laboratory with similar computer network equipment as the computer network equipment in the computer network. In this manner, the hardware/software is tested to troubleshoot the hardware/software prior to integration into the computer network.

### BRIEF DESCRIPTION OF THE DRAWINGS

Aspects of the present disclosure are best understood from the following detailed description when read with the accompanying figures. In accordance with the standard practice in the industry, various features are not drawn to scale. In fact, the dimensions of the various features are arbitrarily increased or reduced for clarity of discussion.

FIG. 1 is a block diagram of a computing system, in accordance with some embodiments.

FIG. 2 is a block diagram of an NDUT connected to a VN, in accordance with some embodiments.

FIG. 3 is a flow diagram of a method of performing a test on an NDUT, in accordance with some embodiments.

FIG. 4 is a table that describes testing scenarios for an NDUT, in accordance with some embodiments.

FIG. 5 is a table that describes testing scenarios for an NDUT, in accordance with some embodiments.

FIG. 6 is test result data, in accordance with some embodiments.

FIG. 7 is test result data, in accordance with some embodiments.

FIG. 8 is test result data, in accordance with some embodiments.

FIG. 9 is a flow diagram of a method of testing a device of a computer network, in accordance with some embodiments.

### DETAILED DESCRIPTION

The following disclosure provides many different embodiments, or examples, for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows includes embodiments in which the first and second features are formed in direct contact, and further include embodiments in which additional features are formed between the first and second features, such that the first and second features are unable to be in direct contact. In addition, the present disclosure repeats reference numerals and/or letters in the various examples. This repetition is for the purpose of simplicity and clarity and does not dictate a relationship between the various embodiments and/or configurations discussed.

Further, spatially relative terms, such as beneath, below, lower, above, upper and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Systems and methods of testing a device for a computer network are disclosed. In some embodiments, the computer network is or includes a cellular network. The device is referred to as a network device under test (NDUT). The NDUT is a physical device that is to be tested to determine whether the NDUT is operational in the computer network, or the physical device is unable to operate appropriately or the test results in problems or failure within the computer network in response to being integrated into the computer network. However, in some embodiments, computer network involves large number of and physical computer network devices. Creating a duplicate of the and physical computer network devices in a laboratory is cumbersome and expensive. Accordingly, this disclosure includes embodiments that test the NDUT by implementing one or more virtual machines (VMs). In some embodiments, the VMs are configured as a virtual network (VN). VMs in VNs are implemented on computer devices (e.g., servers) and emulate the behavior of the and physical network devices. In some embodiments, the VMs generate the same input data that the NDUT receives when integrated into the computer network. By utilizing VMs in VNs, the NDUT is tested without some or all of the physical computer network devices from the computer network. In this manner, the NDUTs are tested in a less cumbersome and an unexpensive manner, in accordance with some embodiments.

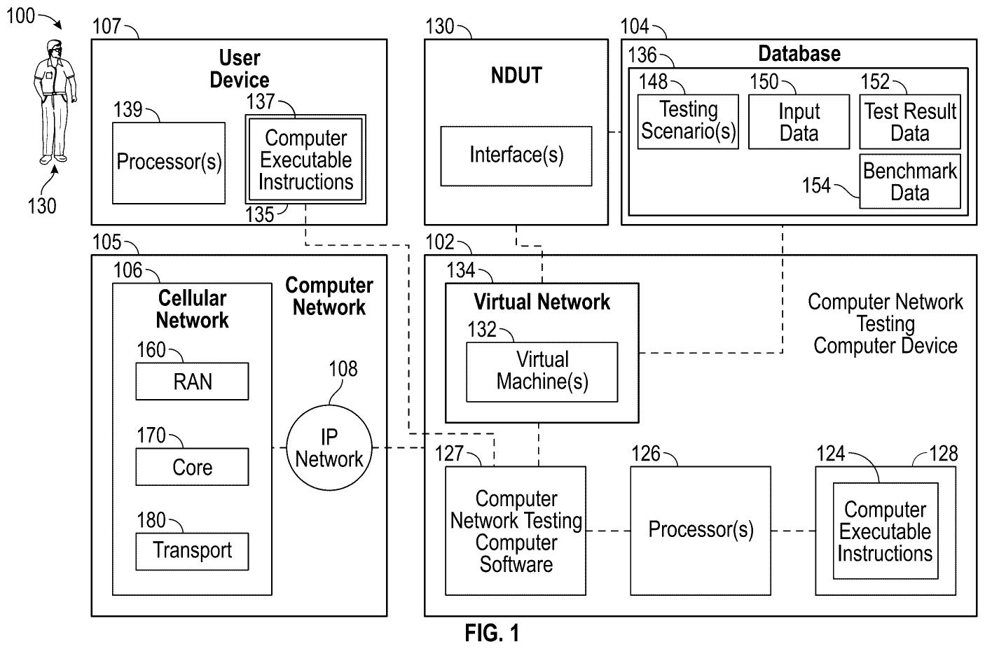

FIG. 1 is a block diagram of a computing system 100, in accordance with some embodiments.

The computing system 100 includes a computer network testing device 102, at least one database 104, a computer network 105, and a user device 107. In FIG. 1, the computer network 105 includes a cellular network 106 and an internet protocol (IP) network 108. In some embodiments, the computer network 105 includes only an IP network 108. In some embodiments, the computer network 105 includes only the cellular network 106. In some embodiments, the computer network 105 includes multiple IP networks, like the IP network 108. In some embodiments, the computer network 105 includes multiple cellular networks, like the cellular network 106.

In some embodiments, the computer network testing device 102 and the cellular network 106 are connected to each other through the IP network 108. In some embodiments, the IP network 108 includes a wide area network (WAN) (i.e., the internet), a local area network (LAN), a wide area local area network (WLAN), and/or the like. In some embodiments, the cellular network 106 includes a wireless WAN (WWAN).

The cellular network 106 includes a radio access network (RAN) 160. The RAN 160 is the radio element of the cellular network 106. The RAN 160 includes network elements such as base stations that include one or more radio transceivers. The base stations cover land areas called cells. User equipment, such as cell phones, smartphones, laptops, etc., connect to each of the base stations that cover the cells. RAN 160 connects to the core 170 through back haul links, which are provided by the transport 180.

The core 170 is a part of the overall cellular network 106. The core 170 allows mobile subscribers to get access to the services (e.g., international calling, text messaging, local cellular calls). In some embodiments, the core 170 is responsible for functions such as maintaining subscriber profile information, subscriber location, authentication of services, and the necessary switching functions for voice and data sessions. The core 170 includes network elements. In some embodiments, the network elements include a Mobility Management Entity (MME), a Serving Gateway, a Multimedia Broadcast Multicast Service (MBMS) Gateway, a Broadcast Multicast Service Center (BM-SC), and a Packet Data Network (PDN) Gateway. In some embodiments, the MME is in communication with a Home Subscriber Server (HSS). The MME is the control node that processes the signaling between the user equipment and the core 170. Generally, the MME provides bearer and connection management. In some embodiments, Internet protocol (IP) packets are transferred through a serving gateway, which is connected to the IP network 108.

The transport 180 refers to the transport network that connects the core 170 and the RAN 160 of the cellular network 106. The transport 180 includes network elements 182 such as backhaul links, connectors, relays, Voice over IP devices, or other suitable network elements within embodiment of the present disclosure. In some embodiments, the transport 180 includes a fronthaul that connects a macro cell to the small cells, radio units, digital units and/or the like.

The computer network testing device 102 (server 102 in some embodiments) is a computer device that includes at least one processor 126 and a non-transitory computer readable medium 128. The non-transitory computer readable medium 128 stores computer executable instructions 124. In some embodiments, non-transitory computer readable medium 128 includes a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that is used to store computer executable code in the form of instructions or data structures that are accessed by a computer device. When the processor 126 executes the computer executable instructions 124, the processor 126 executes the computer network testing software 127.

In some embodiments, one or more new network devices (e.g., network elements (NEs)) are to be integrated into the computer network 105. However, prior to integration of the network devices into the computer network 105, the performance of these new network devices is tested to ensure that the new network devices are appropriately integrated into the computer network 105 without causing problems. Thus, troubleshooting and system performance are tested prior to the integration of the network device. In FIG. 1, the network device that is being tested prior to integration into the computer network 105 is referred to as a network device under test (NDUT) 130. In some embodiments, the NDUT 130 or a network device like the NDUT 130 is to be integrated into the IP network 108. In some embodiments, the NDUT 130 or a network device like the NDUT 130 is to be integrated into the RAN 160. In some embodiments, the NDUT 130 or a network device like the NDUT 130 is to be integrated into the core 170. In some embodiments, the NDUT 130 or a network device like the NDUT 130 is to be integrated into the transport 180.

To test the performance of the NDUT 130, the computer network testing computer software 127 is configured to implement one or more virtual machines (VMs) 130. A VM 132 is computer software that simulates the operation of a physical computer device. In some embodiments, VMs 130 are software defined computers that operate within the server 102 that exist through the implementation of software code. In some embodiments, the virtual version of a computer device, with dedicated amounts of CPU, memory, and storage are borrowed from server 102 (e.g., a server in a cloud provider's datacenter). In some embodiments, the VM 132 is defined by a computer file (e.g., an image file), that configures the VM 132 to operate like a computer device. In some embodiments, VMs 132 operate as a separate computing environment that is distinct from the computing environment of the server 102 that is implementing the VM 132. For example, in some embodiments, the VM 132 runs an operating system that is different than the server 102 that is implementing the VM 132. In some embodiments, the VM 132 is partitioned from the rest of the server 102 so that software implemented inside the VM 132 doesn't interfere with the operating system of the server 102.

The computer network testing software 127 is configured to automate change request execute a testing scenario 148 on the VMs 132 implemented by the computer network testing computing device 102 so that the one or more VMs 132 generate input data 150 as result of executing the testing scenario 148. In some embodiments, the testing scenario 148 is a testing script that is stored in the database 104. Various testing scenarios 148 are stored in the database 104 in some embodiments to test different types of NDUTs 130 in different situations.

In some embodiments, the testing scenario 150 is selected from a plurality of testing scenarios 150 for implementation by the VMs 132. In some embodiments, the testing scenario 150 that is to be implemented by the VMs 132 is selected by a user 130 through the user device 107. The user device 107 includes a non-transitory computer readable medium 135 and at least one processor 139. The non-transitory computer readable medium 135 stores computer executable instructions 137. In response to the processor 139 executing the computer executable instructions 137, the user device 107 is configured to receive user inputs and send the user inputs to the computer network testing computer software 127. Computer network testing computer software 127 processes the user inputs to select the appropriate testing scenario 148 and to receive relevant parameter values for the testing scenarios from the user device 107.

In some embodiments, the VMs 132 are configured to operate as a virtual network (VN) 134. In some embodiments, the VN 134 simulates at least a portion of the computer network 105. In some embodiments, the VN 134 simulates at least a portion of the IP network 108. In some embodiments, the VN 134 simulates at least a portion of the cellular network 105.

In some embodiments, the input data 150 is the same input data that is generated by the portion of the computer network 105 that is feeding data to the NDUT 132 in response to the NDUT 132 being integrated into the computer network 105. The input data is received by the NDUT 132 through one or more interface(s). In some embodiments, the VMs 132 in the VN 134 thus generate the input data 150 in the same format and with the same signaling as the input data by the portion of the computer network 105 that is feeding data to the NDUT 132 in response to the NDUT 132 being integrated into the computer network 105. In some embodiments, the input data 150 is fed directly to the NDUT 130 from the VMs 132 in the VN 134. In some embodiments, the input data 150 is stored as logs in the data base 104. In some embodiments, the NDUT 130 receives the input data 150 after being stored in the database 104 by the VMs 132.

The NDUT 130 generates test result data 152 in response to the input data 150 from the one or more VMs 132. The test result data 152 indicates the performance of the NDUT 130 under the testing scenario 148 implemented by the VM(s) 132. The computer network testing computer software 127 is configured to detect whether the NDUT 130 passes the implemented testing scenario 148 based on the test result data 152. In some embodiments, the test result data 152 is stored in the database 104. In some embodiments, to determine whether the NDUT 130 passes the implemented testing scenario 148, benchmark data 154 is generated by the computer network testing computer software 127 that establishes one or more benchmarks to determine whether the NDUT passes the implemented testing scenario 148. In some embodiments, the benchmarks described by the benchmark data 154 is determined based on user input received from the user device 107. To detect whether the NDUT 130 passes the testing scenario 148 based on the test result data 152, the computer network testing computer software 127 is configured to detect whether the test result data 152 meets the benchmarks established by the benchmark data 154. In response to passing the testing scenario 148 (or the testing scenarios 148), the NDUT 130 or a network device like the NDUT 130 is integrated into the computer network 105.

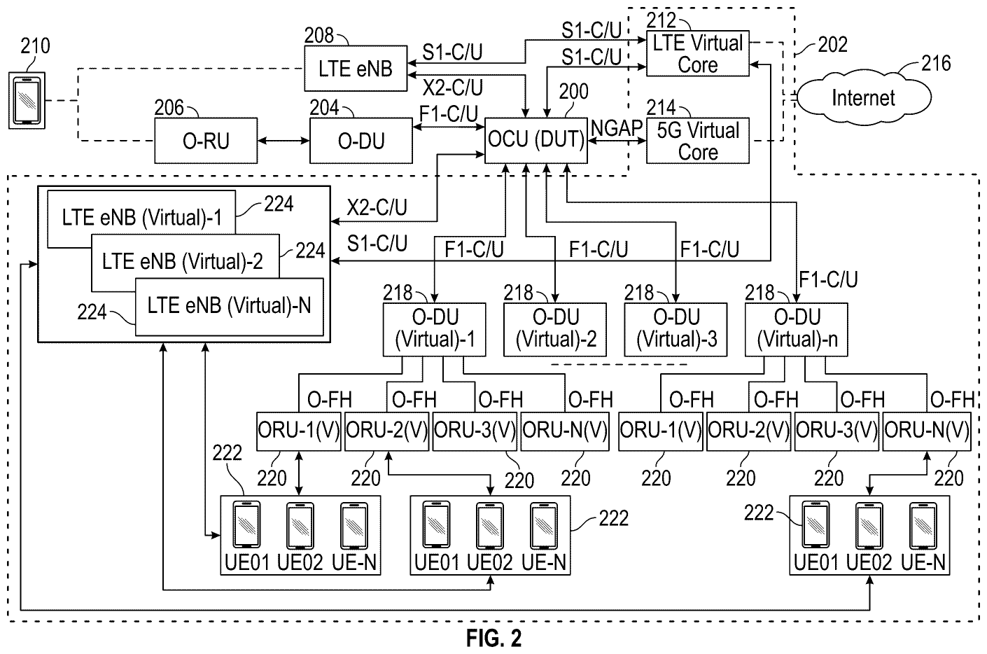

FIG. 2 is a block diagram of an NDUT 200 connected to a VN 202 in order to test the NDUT 200, in accordance with some embodiments.

NDUT 200 is an example of NDUT 130 in FIG. 1, in accordance with some embodiments. VN 202 is an example of VN 134, in accordance with some embodiments. In some embodiments, the VN 202 is implemented by the computer network testing computer software 127

In FIG. 2, the NDUT 130 is a centralized unit (CU). More specifically, the CU is for Open RAN (ORAN) and is an Open CU (OCU) device under test (DUT). By implementing one or more testing scenarios with the VN 202, systems tests are run that ensure that the NDUT 200 is able to handle the capacity and the network traffic once the NDUT 200 is actually integrated into the computer network 105. Different types of testing scenarios are implemented to determine whether the NDUT 200 performs during handovers, data calls, PWS delivery, F1 procedure, X2C procedure, Ip-Sec, or other operations material to embodiments of the present disclosure that ensure software quality during software overload condition and hardware performance at peak use times. Using the test result data resulting from the implementation of the testing scenario, a network designer formulates a topology design that maximizes software and hardware resource efficiency.

A 5G RAN is divided into two physical entities named CU (Centralized Unit) and DU (Distributed Unit). With reference to the discussion of open systems interconnection (OSI is a model that describes seven layers that computer systems use to communicate over a network) layers, the CU provides support for the higher layers of the protocol stack such as service data adaptation protocol (SDAP is a protocol specified by 3GPP and maps the quality of service flow to the bearer service), packet data convergence protocol (PDCP provides services to the RRC and user plane upper layers, e.g. IP at the UE or to the relay at the base station) and radio resource control (RRC is a network layer protocol used between UE and base station) while the DU provides support for the lower layers of the protocol stack such as radio link control (RLC is a layer 2 radio link protocol used in UMTS, LTE and 5G), media access control (MAC is a unique identifier assigned to a network interface controller (NIC) for use as a network address in communications within a network segment) and physical layer. One CU controls multiple DUs, for example more than 100 DUs are connected to one CU. Each DU supports one or more cells, like cells 514, so one CU controls hundreds of cells.

VMs are noted by the adjective virtual, while non-virtual and physical machines are noted by the adjective physical through this discussion. In this embodiment, the NDUT 200 is connected to network devices in addition to the VN 202. The network devices include an open distributed unit (O-DU) 204. The O-DU 204 and the NDUT 200 are coupled through and F1-C/U interface. The F1 interface connects a gNB CU to a gNB DU. This interface is applicable to the CU-DU split gNB architecture. The control plane of the F1 (F1-C) allows signaling between the CU and DU, while the user plane of the F1 (F1-U) allows the transfer of application data. The O-DU 204 is connected to an open radio unit (O-RU) 206. The radio units (RU) purpose is to convert radio signals sent to and from the antenna to a digital signal that is transmitted over the fronthaul to DU. In some embodiments, the O-DU 204 is connected to the O-RU 206 through an open front haul (O-FH) interface. The front haul interface, according to the O-RAN fronthaul specification, performs communication between O-DU and O-RU and consists of multiple hardware (HW) and software (SW) components. The NDUT 200 is connected to an LTE eNB 208 through an X2-C/U interface. Both the O-RU 206 and the LTE eNB 208 are connected to user equipment (UE) 210. The X2 interface is broken up into the X2-C and X2-U interfaces, where the former is for the control plane and the latter is for the user plane. Both are originally designed by 3GPP for sending information between a 4G network's eNBs, or between an eNB and a 5G network's en-gNB. In the O-RAN Alliance's documentation, the interface has the same principles and protocols.

The NDUT 200 is also coupled to the VN 202. The VN 202 includes a plurality of VMs. The VMs includes an LTE Virtual Core 212 and a 5G Virtual Core 214. The LTE Virtual Core 212 and the 5G Virtual Core 214 are connected to the internet 216. In some embodiments, the internet 216 is an example of the IP network 108 in FIG. 1. The LTE Virtual Core 212 is connected to the NDUT 200 through an S1-C/U interface. The LTE Virtual Core 212 is connected to the LTE eNB 208 through an S1-C/U interface. The 5G Virtual Core 214 is connected to the NDUT 200 through an NGAP interface. S1-CP is the control plane and the S1-U is the user plane external interface (S1-U) defined between the LTE eNodeB and the LTE serving gateway (S-GW).

The VN 202 further includes Virtual O-DUs 218. Each of the Virtual O-DUs 218 is connected to the NDUT 200 through F1-C/U interfaces. Each of the Virtual O-DUs 218 are connected to Virtual O-RUs 220 through virtual O-FH interfaces. Each of the Virtual O-RUs 220 is connected to Virtual UEs 222. The Virtual UEs 222 are connected to Virtual LTE eNBs 224. The Virtual LTE eNBs 224 are connected to the NDUT 200 through an X2-C/CU interface.

Testing scenarios are then implemented using the VN 202 to determine the performance of the NDUT 200 in different traffic and network conditions to determine whether the NDUT 200 has any performance issues. If not, the NDUT 200 or a network device similar (e.g., the same) as the NDUT 200 is integrated into the cellular network 106. In some embodiments, the advantage of using the VN 202 is clear given the expense and logistics to bring the network devices that are emulated by the VN 202 into a laboratory for testing of the NDUT 200.

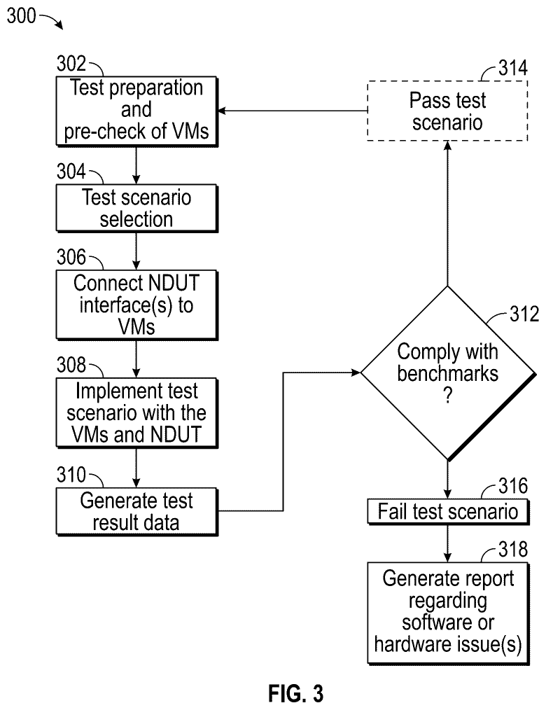

FIG. 3 is a flow diagram 300 of a method of performing a test on an NDUT, in accordance with some embodiments.

Flow diagram 300 includes blocks 302-318. In some embodiments, flow diagram 300 is performed by the computer network testing computer software 127 shown in FIG. 1. In some embodiments, the NDUT is the NDUT 200 shown in FIG. 2 and the test is performed with the VN 202 shown in FIG. 2. Flow begins at block 302.

At block 302, the computer network testing computer device 102 is prepared for performing a test on the NDUT 200 and a precheck of the computer network testing computer software 127 is performed. In some embodiments, this includes implementing the VMs (e.g., VMs 212, 214, 218, 220, 222, and 224) in the VN 202 and detecting whether the VMs are operational. In some embodiments, the user 130 through the user device 107 ensures that the VMs are running and that there are no alarms or flags that indicate problems in the operation of the VMs. Flow then proceeds to block 304.

At block 304, a testing scenario is selected from a plurality of testing scenarios for execution. In some embodiments, the user 130 selects the testing scenario through the user device 107. The user 130 also generates user inputs through the user device 107 the testing scenario, in some embodiments. The user inputs provide parameter values for the testing scenario selected. Testing scenarios include a DU Setup Scenario (i.e., F1 Setup Procedure), an Ip-sec Tunnel Establishment Scenario, Handover Profile and No of Handover Transection Scenario. User input includes several types of VMs to be implemented, a test duration, a description of network traffic and an amount of network traffic, and/or the like. In some embodiments, the testing scenario is a test script. In some embodiments, the test script is loaded in response to the selection of the test scrip and user input relevant to the test script. Flow then proceeds to block 306.

At block 306, a connection between the interface(s) of the NDUT 200 and the VMs is established. Examples of interfaces of the NDUT 200 include F1-C/U, X2-C/U, NGAP (provides the control plane signaling between NG-RAN node and the Access and Mobility Management Function (AMF)), and/or the like. Flow then proceeds to block 308.

At block 308, the computer network testing computer software 127 implements the selected testing scenario with the VMs in the VN 202 and the NDUT 200. As discussed previously with respect to FIG. 1, the VMs in the VN 202 generate input data in the same manner as corresponding network devices under the testing scenario. The input data is input into the NDUT 200. Flow then proceeds to block 310.

At block 310, the NDUT 200 generates test result data in response to the input data resulting from block 308. In some embodiments, the test result data includes statistical validation of the NDUT's performance, system stability parameters, 3GPP specification call flows, and reports indicating any crashes or abnormal behavior by the NDUT 200.

At block 312, the test result data is analyzed to determine whether the NDUT 200 complies with benchmarks. In response to determining that the test result data generated by NDUT 200 complies with the benchmarks, the NDUT 200 passes the testing scenario at block 314. In some embodiments, the user 130 then proceeds again to block 302 to implement another testing scenario. In other embodiments, no more testing scenarios are implemented and the NDUT 200 or a network device like the NDUT 200 is integrated into the cellular network 106.

In response to determining that the test result data generated by the NDUT 200 does not comply with the benchmarks, the NDUT 200 does not pass the testing scenario at block 316. In response to the NDUT 200 not passing the testing scenario, the computer network testing computer software 127 generates a report regarding any software or hardware issues resulting from the testing scenario at block 318.

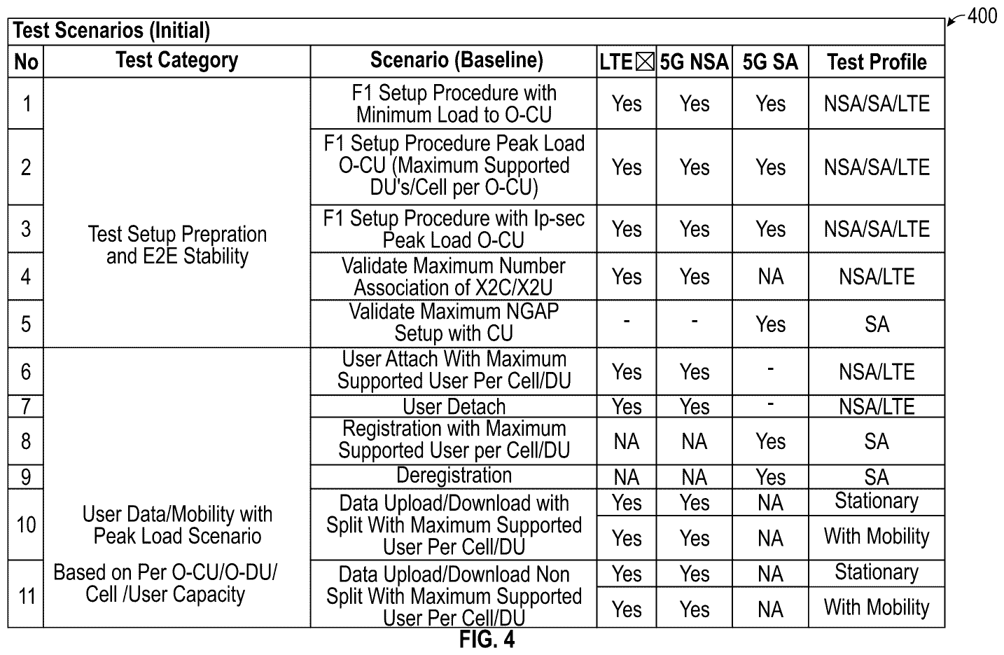

FIG. 4 is a table 400 that describes various testing scenarios for an NDUT, in accordance with some embodiments.

The testing scenarios shown in the table 400 relate to an embodiment of testing scenarios when the NDUT is an O-CU. Table 400 also indicates whether the testing scenario is related to LTE, 5G NSA, 5G SA, and the technologies of the test profile.

Testing scenarios 1-5 are related to testing scenarios for setting up a portion of a cellular network with the NDUT and checking the stability of the portion of the cellular network with the NDUT. In some embodiments, the testing scenarios 1-5 are related to VN (e.g., VN 202) is DU-Simulation environment running an end-to-end (E2E) O-RAN Real Environment.

Testing scenario 1 is a testing scenario that implements an F1 Setup Scenario to determine the minimum load of the NDUT (i.e., in this example, an O-CU).

Testing scenario 2 is a testing scenario that determines a peak load of the NDUT (i.e., Maximum Supported DU's/Cell per O-CU).

Testing scenario 3 is a testing scenario that the peak load of the NDUT with IP-Sec.

Testing scenario 4 is a testing scenario that validates the maximum number of associated X2C/X2U interfaces that are connectable with the NDUT.

Testing scenario 5 is a testing scenario that validates the maximum number of associated NGAP interfaces that are connectable with the NDUT.

Testing scenarios 6-11 are related to testing the performance of the NDUT given certain scenarios related to UEs being simulated by the VN.

Testing scenario 6 is a testing scenario that detects the maximum number of supported users that connect to the NDUT.

Testing scenario 7 is a testing scenario that detects the maximum number of users that detach from the NDUT.

Testing scenario 8 is a testing scenario that detects the maximum number of users that register with a maximum number of user devices to the NDUT.

Testing scenario 9 is a testing scenario that detects the number of users that deregister from the NDUT.

Testing scenario 10 is a testing scenario that test the maximum supported users that provide data upload and data download split per cell connected to the NDUT.

Testing scenario 11 is a testing scenario that test the maximum supported users that provide data upload and data download non-split per cell connected to the NDUT.

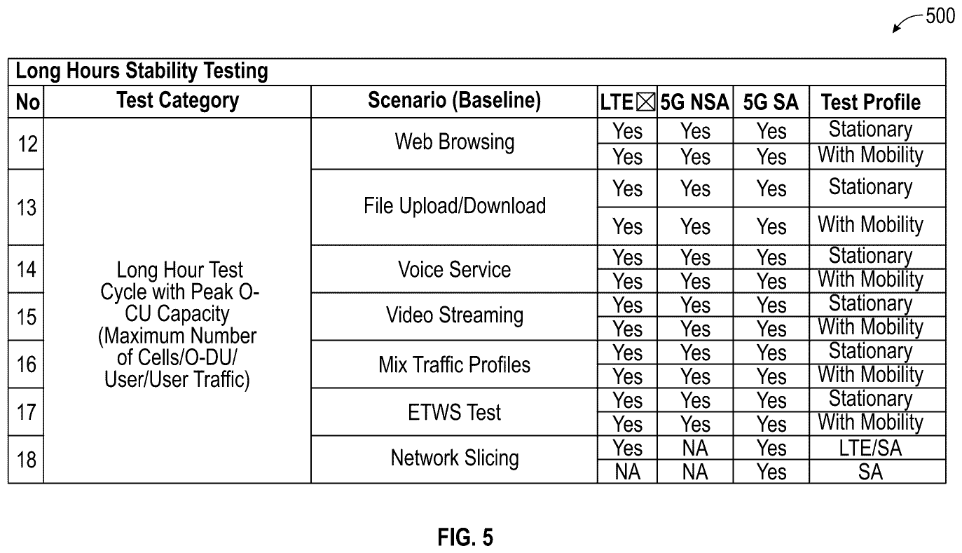

FIG. 5 is a table 500 that describes various testing scenarios for an NDUT, in accordance with some embodiments.

Testing scenarios 12-18 are related to testing the performance of the NDUT throughout an extended period by running a testing scenario being simulated by the VN.

Testing scenario 12 is a testing scenario that detects the performance of the NDUT given several users web browsing throughout an extended period of time through their user devices.

Testing scenario 13 is a testing scenario that detects the performance of the NDUT given several users uploading and downloading files throughout an extended period of time through their user devices.

Testing scenario 14 is a testing scenario that detects the performance of the NDUT given several users implementing voice services throughout an extended period of time through their user devices.

Testing scenario 15 is a testing scenario that detects the performance of the NDUT given several users implementing video streaming services throughout an extended period of time through their user devices.

Testing scenario 16 is a testing scenario that detects the performance of the NDUT given several users implementing a mix of the services being implemented in testing scenarios 12-15 throughout an extended period through their user devices.

Testing scenario 17 is a testing scenario that detects the performance of the NDUT given several users implementing earthquake or tsunami warning system (ETWS is a kind of public warning system (PWS) to notify the UEs in a specific area of emergency like Earthquake or Tsunami) test throughout an extended period through their user devices.

Testing scenario 18 is a testing scenario that detects the performance of the NDUT given several users implementing network slicing throughout an extended period through their user devices. 5G network slicing is a network architecture that enables the multiplexing of virtualized and independent logical networks on the same physical network infrastructure. Each network slice is an isolated end-to-end network tailored to fulfil diverse requirements requested by a particular application. For this reason, this technology supports 5G mobile networks that are designed to efficiently embrace a plethora of services with different service level requirements (SLR). The realization of this service-oriented view of the network leverages on the concepts of software-defined networking (SDN) and network function virtualization (NFV) that allow the implementation of flexible and scalable network slices on top of a common network infrastructure.

From a business model perspective, each network slice is administrated by a mobile virtual network operator (MVNO). The infrastructure provider (the owner of the telecommunication infrastructure) leases physical resources to the MVNOs that share the underlying physical network. According to the availability of the assigned resources, a MVNO autonomously deploys multiple network slices that are customized to the various applications provided to users.

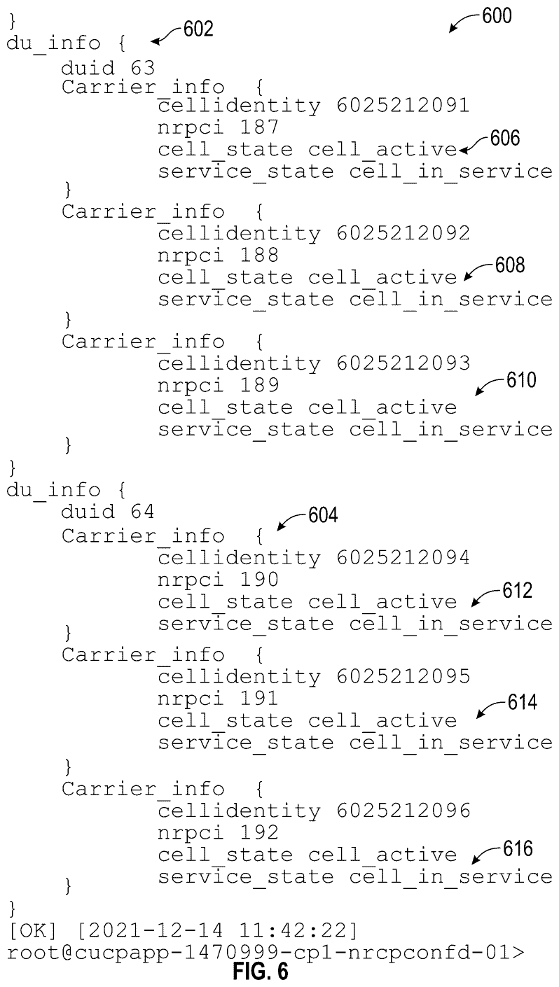

FIG. 6 is test result data, in accordance with some embodiments.

FIG. 6 is test result data for testing scenario 8 in FIG. 4. The test result data is a data structure 600. The data structure 600 includes du_info structures 602, 604. Each of the du_info structures 602, 604 includes an identification field of the DU (i.e., duid in du_info structures 602, 604). The du_info structure 602 includes carrier information substructures 606, 608, 610 (i.e., carrier_info in du_info structure 602). The du_info structure 604 includes carrier information substructures 612, 614, 616 (i.e., carrier_info in du_info structure 604).

Each of the carrier information substructures 606, 608, 610, 612, 614, 616 includes an identity of a cell (i.e., cellidentity in the carrier information substructures 606, 608, 610, 612, 614, 616). Each of the carrier information substructures 606, 608, 610, 612, 614, 616 includes an XXX (i.e., nrpci in the carrier information substructures 606, 608, 610, 612, 614, 616). Each 5G new radio (NR) cell corresponds to a Physical Cell ID (PCI) and the PCI is used to distinguish cells on the radio side. The PCI planning for 5G NR is like PCI planning for LTE and scrambling code planning for 3G UMTS. Each of the carrier information substructures 606, 608, 610, 612, 614, 616 includes a field that identifies a state of a cell (i.e., cell_state in the carrier information substructures 606, 608, 610, 612, 614, 616). Each of the carrier information substructures 606, 608, 610, 612, 614, 616 includes a field that identifies a service state related to a cell (i.e., service_state in the carrier information substructures 606, 608, 610, 612, 614, 616).

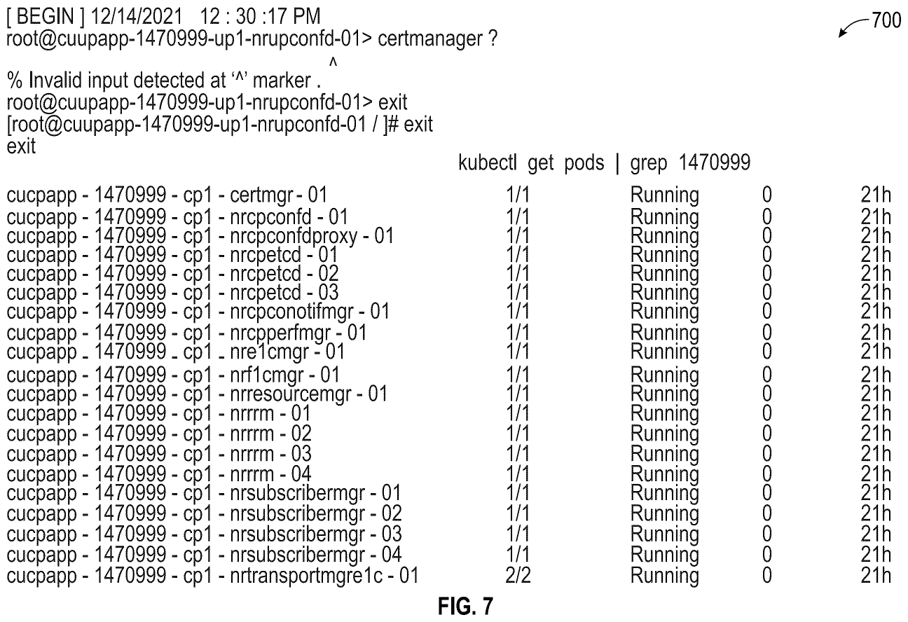

FIG. 7 is test result data, in accordance with some embodiments.

FIG. 7 is test result data for testing scenario 1 in FIG. 4. The test result data is a table 700 that identifies different software applications being implemented on an NDUT. The table 700 identifies that the NDUT has run the application for an extended period of 21 hours. In this embodiment, the test result data indicates that the testing scenario is successful since the benchmark is whether the applications are successfully run on the NDUT for 21 hours straight.

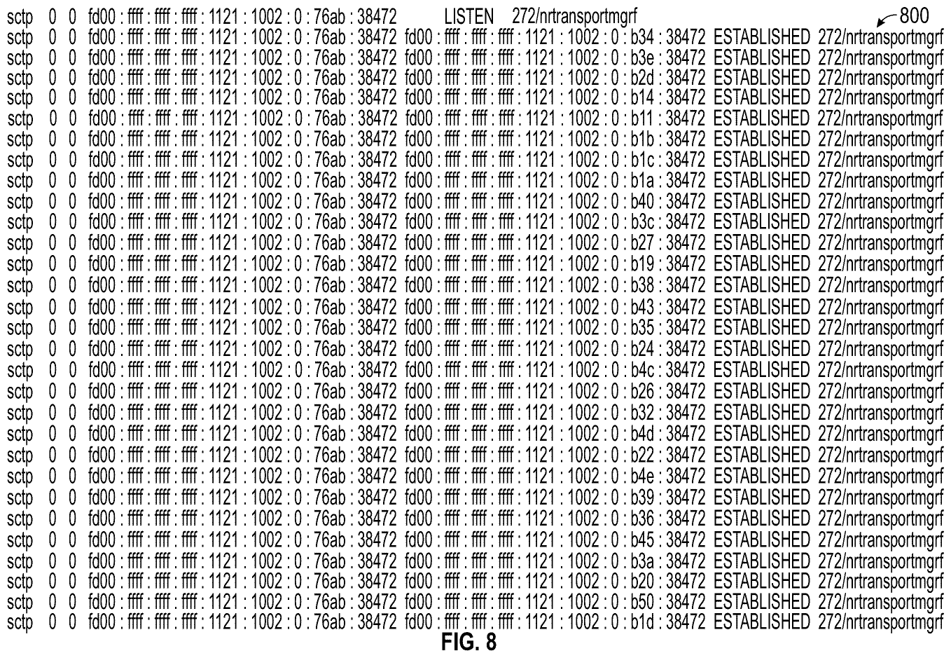

FIG. 8 is test result data, in accordance with some embodiments.

FIG. 8 is test result data for testing scenario 15 in FIG. 5. The test result data is a table 800 that identifies whether an NDUT connects to user devices with specific IP addresses. The table 800 identifies that the NDUT has established a connection with the user devices. In this embodiment, the test result data indicates that the testing scenario is successful since the benchmark is whether the NDUT successfully established a connection to each of the user devices identified by the IP addresses.

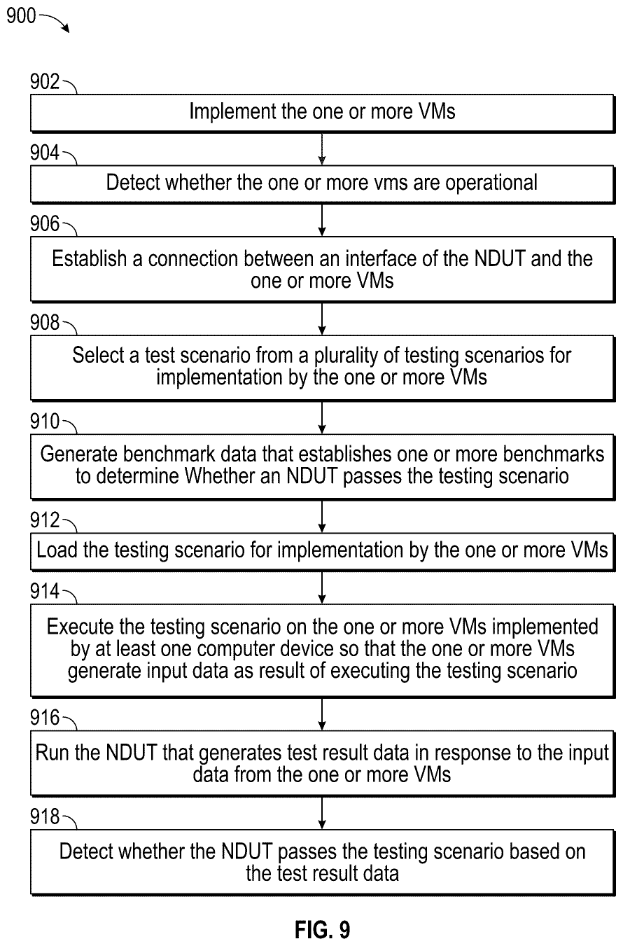

FIG. 9 is a flow diagram 900 of a method of testing a device of a computer network, in accordance with some embodiments.

In some embodiments, flow diagram 900 is implemented by the computer network testing computer software 127 of the computer network testing computer device 102. Flow diagram 900 includes blocks 902-918. Flow begins at block 902.

At block 902, one or more VMs are implemented. Examples of the VMs include VMs 132 in FIG. 1 and VMs 212, 214, 218, 220, 222, and 224 in FIG. 2. In some embodiments, the VMs are configured as a VN, such as VN 134 in FIG. 1 and VN 202 in FIG. 2. Flow then proceeds to block 904.

At block 904, a determination is made whether the one or more VMs are operational. Flow then proceeds to block 906.

At block 906, a connection is established between an interface of the NDUT and the one or more VMs. Examples of the NDUT are the NDUT 130 in FIG. 1 and the NDUT 200 in FIG. 2. An example of the interface is the interface of the NDUT 130 shown in FIG. 1, in accordance with some embodiments. Other examples of the interface are the F1-C/U, X2-C/U, and NGAP interfaces shown in FIG. 2, in accordance with some embodiments. Flow then proceeds to block 908.

At block 908, a testing scenario is selected from a plurality of scenarios for implementation of the one or more VMs. An example of the testing scenarios are the testing scenarios 148 in FIG. 1. Other example of the testing scenarios is testing scenarios 1-18 discussed in FIG. 4 and FIG. 5. Flow then proceeds to block 910.

At block 910, benchmark data that established one or more benchmarks to determine whether an NDUT passes the testing scenario. An example of the benchmark data is the benchmark data 154 in FIG. 1. Flow then proceeds to block 912.

At block 912, the testing scenario is loaded for implementation by the one or more VMs. In some embodiments, the testing scenario is a testing script. Flow then proceeds to block 914.

At block 914, the testing scenarios is executed on the one or more VMs implemented by at least one computer device so that the one or more VMs generate input data as a result of executing the testing scenario. An example of the input data is the input data 150 shown in FIG. 1. Flow then proceeds to block 916.

At block 916, the NDUT is run to generate test result data in response to the input data from the one or more VMs. An example of the test result data is the test result data 152 shown in FIG. 1. Other examples of the test result data are shown in FIG. 6, FIG. 7, and FIG. 8. Flow then proceeds to block 918.

At block 918, detection is made as to whether the NDUT passes the testing scenario based on the test result data. In some embodiments, whether the NDUT passes the testing scenario is based on the benchmark of the benchmark data.

In some embodiments, a method of testing a device for a computer network, includes: executing a testing scenario on one or more virtual machines (VMs) implemented by at least one computer device so that the one or more VMs generate input data as result of executing the testing scenario; running a network device under test (NDUT) that generates test result data in response to the input data from the one or more VMs; and detecting whether the NDUT passes the testing scenario based on the test result data. In some embodiments, the method further includes: integrating the NDUT or a second network device similar to the NDUT into the computer network in response to the NDUT passing the testing scenario. In some embodiments, the computer network includes a cellular network; the one or more VMs are configured to operate as a virtual network (VN); and the VN simulates at least a portion of the cellular network. In some embodiments, prior to the executing of the testing scenario on the one or more VMs, the method further includes: implementing the one or more VMs; detecting whether the one or more VMs are operational; and loading the testing scenario for implementation by the one or more VMs. In some embodiments, prior to the loading the testing scenario for implementation by the one or more VMs, the method further includes: selecting the testing scenario from a plurality of testing scenarios for implementation by the one or more VMs. In some embodiments, prior to the executing of the testing scenario on the one or more VMs, the method further includes: establishing a connection between an interface of the NDUT and the one or more VMs. In some embodiments, the method further includes: generating benchmark data that establishes one or more benchmarks to determine whether the NDUT passes the testing scenario; wherein the detecting whether the NDUT passes the testing scenario based on the test result data includes: detecting whether the test result data meets the benchmarks established by the benchmark data.

In some embodiments, an apparatus for testing a device for a computer network, includes: a non-transient computer readable medium that stores computer executable instructions: one or more processors, wherein, in response to the one or more processors executing the computer executable instructions, the one or more processors are configured to: execute a testing scenario on one or more virtual machines (VMs) so that the one or more VMs generate input data as result of executing a testing scenario; run a network device under test (NDUT) that generates test result data in response to the input data from the one or more VMs; and detect whether the NDUT passes the testing scenario based on the test result data. In some embodiments, the one or more VMs are configured to operate as a virtual network (VN); and the VN simulates at least a portion of a cellular network. In some embodiments, prior to the executing of the testing scenario on the one or more VMs, the one or more processors are further configured to: implement the one or more VMs; detect whether the one or more VMs are operational; and load the testing scenario for implementation by the one or more VMs. In some embodiments, prior to the loading the testing scenario for implementation by the one or more VMs, the one or more processors are further configured to: select the testing scenario from a plurality of testing scenarios for implementation by the one or more VMs. In some embodiments, prior to the executing of the testing scenario on the one or more VMs, the one or more processors are further configured to: establish a connection between an interface of the NDUT and the one or more VMs. In some embodiments, the one or more processors are further configured to: generate benchmark data that establishes one or more benchmarks to determine whether the NDUT passes the testing scenario; wherein the one or more processors are configured to detect whether the NDUT passes the testing scenario based on the test result data by: detecting whether the test result data meets the benchmarks established by the benchmark data. In some embodiments, the testing scenario includes a testing script.

In some embodiments, a non-transient computer readable medium that stores computer executable instructions wherein, in response to one or more processors executing the computer executable instructions, the one or more processors are configured to: execute a testing scenario on one or more virtual machines (VMs) so that the one or more VMs generate input data as result of executing the testing scenario; run a network device under test (NDUT) that generates test result data in response to the input data from the one or more VMs; and detect whether the NDUT passes the testing scenario based on the test result data. In some embodiments, the one or more VMs are configured to operate as a virtual network (VN); and the VN simulates at least a portion of a cellular network. In some embodiments, prior to the executing of the testing scenario on the one or more VMs, the one or more processors are further configured to: implement the one or more VMs; detect whether the one or more VMs are operational; and load the testing scenario for implementation by the one or more VMs. In some embodiments, prior to the loading the testing scenario for implementation by the one or more VMs, the one or more processors are further configured to: select the testing scenario from a plurality of testing scenarios for implementation by the one or more VMs. In some embodiments, prior to the executing of the testing scenario on the one or more VMs, the one or more processors are further configured to: establish a connection between an interface of the NDUT and the one or more VMs. In some embodiments, the one or more processors are further configured to: generate benchmark data that establishes one or more benchmarks to determine whether the NDUT passes the testing scenario; wherein the one or more processors are configured to detect whether the NDUT passes the testing scenario based on the test result data by: detecting whether the test result data meets the benchmarks established by the benchmark data.

The foregoing outlines features of several embodiments so that those skilled in the art better understands the aspects of the present disclosure. Those skilled in the art appreciate ready use of the present disclosure as a basis for designing or modifying other processes and structures for carrying out the same purposes and/or achieving the same advantages of the embodiments introduced herein. Those skilled in the art also realize that such equivalent constructions do not depart from the spirit and scope of the present disclosure, and that various changes, substitutions, and alterations are made herein without departing from the spirit and scope of the present disclosure.

Aspects of the present disclosure are best understood from the following detailed description when read with the accompanying figures. In accordance with the standard practice in the industry, various features are not drawn to scale. In fact, the dimensions of the various features are arbitrarily increased or reduced for clarity of discussion.

What is claimed is:

1. A method of testing a device for a computer network, comprising:
executing a testing scenario on one or more virtual machines (VMs) implemented by at least one computer device so that the one or more VMs generate input data as a result of executing the testing scenario;
running a network device under test (NDUT) to generate test result data in response to the input data from the one or more VMs; and
detecting whether the NDUT passes the testing scenario based on the test result data.

2. The method of claim 1, further comprising:
integrating the NDUT into the computer network in response to the NDUT passing the testing scenario.

3. The method of claim 1, wherein:
the one or more VMs are configured to operate as a virtual network (VN); and
the VN simulates at least a portion of a cellular network.

4. The method of claim 1, wherein prior to the executing of the testing scenario on the one or more VMs, the method further comprises:
implementing the one or more VMs;
detecting whether each of the one or more VMs are operational; and
loading the testing scenario for implementation by the one or more VMs.

5. The method of claim 4, wherein prior to the loading the testing scenario for implementation by the one or more VMs, the method further comprises:
selecting the testing scenario from a plurality of testing scenarios for implementation by the one or more VMs.

6. The method of claim 1, wherein prior to the executing of the testing scenario on the one or more VMs, the method further comprises:
establishing a connection between an interface of the NDUT and the one or more VMs.

7. The method of claim 1, further comprising:
generating benchmark data that establishes one or more benchmarks to determine whether the NDUT passes the testing scenario;
wherein the detecting whether the NDUT passes the testing scenario based on the test result data comprises:
detecting whether the test result data meets the benchmarks established by the benchmark data.

8. An apparatus for testing a device for a computer network, comprising:
a non-transient computer readable medium that stores computer executable instructions:
one or more processors, wherein, in response to the one or more processors executing the computer executable instructions, the one or more processors are configured to:
execute a testing scenario on one or more virtual machines (VMs) so that the one or more VMs generate input data as result of executing a testing scenario;
run a network device under test (NDUT) to generate test result data in response to the input data from the one or more VMs; and
detect whether the NDUT passes the testing scenario based on the test result data.

9. The apparatus of claim 8, wherein:
the one or more VMs are configured to operate as a virtual network (VN); and
the VN simulates at least a portion of a cellular network.

10. The apparatus of claim 8, wherein prior to the executing of the testing scenario on the one or more VMs, the one or more processors are further configured to:
implement the one or more VMs;
detect whether each of the one or more VMs are operational; and
load the testing scenario for implementation by the one or more VMs.

11. The apparatus of claim 10, wherein prior to the loading the testing scenario for implementation by the one or more VMs, the one or more processors are further configured to:
select the testing scenario from a plurality of testing scenarios for implementation by the one or more VMs.

12. The apparatus of claim 8, wherein prior to the executing of the testing scenario on the one or more VMs, the one or more processors are further configured to:
establish a connection between an interface of the NDUT and the one or more VMs.

13. The apparatus of claim 8, wherein the one or more processors are further configured to:
generate benchmark data that establishes one or more benchmarks to determine whether the NDUT passes the testing scenario;
wherein the one or more processors are configured to detect whether the NDUT passes the testing scenario based on the test result data by:
detecting whether the test result data meets the benchmarks established by the benchmark data.

14. The apparatus of claim 8, wherein the testing scenario comprises a testing script.

15. A non-transient computer readable medium that stores computer executable instructions wherein, in response to one or more processors executing the computer executable instructions, the one or more processors are configured to:
execute a testing scenario on one or more virtual machines (VMs) so that the one or more VMs generate input data as result of executing the testing scenario;
run a network device under test (NDUT) to generate test result data in response to the input data from the one or more VMs; and
detect whether the NDUT passes the testing scenario based on the test result data.

16. The non-transient computer readable medium of claim 15, wherein:
the one or more VMs are configured to operate as a virtual network (VN); and
the VN simulates at least a portion of a cellular network.

17. The non-transient computer readable medium of claim 15, wherein prior to the executing of the testing scenario on the one or more VMs, the one or more processors are further configured to:
implement the one or more VMs;
detect whether each of the one or more VMs are operational; and
load the testing scenario for implementation by the one or more VMs.

18. The non-transient computer readable medium of claim 17, wherein prior to the loading the testing scenario for implementation by the one or more VMs, the one or more processors are further configured to:
select the testing scenario from a plurality of testing scenarios for implementation by the one or more VMs.

19. The non-transient computer readable medium of claim 15, wherein prior to the executing of the testing scenario on the one or more VMs, the one or more processors are further configured to:
establish a connection between an interface of the NDUT and the one or more VMs.

20. The non-transient computer readable medium of claim 15, wherein the one or more processors are further configured to:
generate benchmark data that establishes one or more benchmarks to determine whether the NDUT passes the testing scenario;
wherein the one or more processors are configured to detect whether the NDUT passes the testing scenario based on the test result data by:
detecting whether the test result data meets the benchmarks established by the benchmark data.
